(19) United States
(12) Patent Application Publication
(10) Pub. No.: US 2010/0016011 A1
(43) Pub. Date: Jan. 21, 2010

(54) Method for Collecting Usage Information on Wireless Devices for Ratings Purposes

(75) Inventor: Anand Bernard Alen, Flower Mound, TX (US)

Correspondence Address: Motorola, Inc.;Law Department, 1303 East Algonquin Road, 3rd Floor, Schaumburg, IL, 60196, US

(73) Assignee: MOTOROLA, INC., SCHAUMBURG, IL (US)

(21) Appl. No.: 12/173,806

(22) Filed: Jul. 15, 2008

(51) Int. Cl. H04M 1/00; H04H 60/32

(52) U.S. Cl. 455/550.1; 725/14

(57) ABSTRACT

A system for collecting usage information from a mobile device includes at least one ratings server configured to communicate with a population of mobile devices over a network. The ratings server is configured to receive and collect usage information from the population of mobile devices over the network and to produce ratings of content available to the mobile devices based on the usage information. A method for collecting usage information from a population of mobile devices includes reporting usage information for each mobile device of the population with a ratings application installed on each the mobile device; and receiving and analyzing the usage information with a ratings server to produce ratings of content available to the mobile devices based on the usage information.

### BACKGROUND

The demand for wireless access to information and services is continually increasing. For example, cellular and mobile telephone networks originally provided the ability to make and receive telephone calls wirelessly from any location in a service area. More recent technology allows users of such systems to, for example, access email, browse the worldwide web, send text messages, and transmit photos and video with their mobile devices. One emerging service that is of particular interest to the disclosure at hand is television or video programming broadcasts to mobile devices.

As bandwidth and the ability to transmit more information to mobile devices continually increases, mobile device users are becoming more interested in watching video and television programming on their mobile devices. Consequently, the operators of wireless networks are moving toward the capability to broadcast video and television programming over their networks to the population of mobile devices being served. Broadcasting television programming to a population of mobile devices may present a range of new issues and opportunities for content providers, broadcast services and network operators.

In the traditional television broadcasting model, stationary television sets receive programs through over-the-air broadcasts, cable networks, or satellites. As is commonly known in the art and by all who watch television programming, advertisements are shown to the viewer in this traditional model to generate advertising revenue. Through such advertising, the viewer is informed of the advertiser's products and services, and possibly enticed to purchase the advertised products or services.

Networks providing commercial television programs to viewers in the traditional model typically offer advertisers the opportunity to purchase an interval of time in which to show their advertisements before, during, or after a given program is broadcast. The cost to the advertiser is determined, at least partially, by the number of viewers expected to watch the television program who will then likely see the advertisement. Thus, it is common for advertising time during a popular program and/or during the peak hours of the day to cost many times more than advertising time during an obscure program or at a time when fewer viewers are expected to participate.

Consequently, to calculate the price a network should charge an advertiser for a given advertising time interval, a determination of how many people are viewing the program during which the advertisement will be presented is valuable. The most commonly used method for determining the size of a program's audience is through Nielsen ratings. The Nielsen ratings method was originally developed by Nielsen Media Research during the 1940's and has changed significantly over the years.

Currently, Nielsen ratings are calculated using data from remunerated participants that log their television viewing habits in a diary or, alternatively, allow their viewing habits to be recorded by a set meter. A set meter is an electronic device that is attached to at least one television set in the participant's home and records what programs the occupants of the home watch by monitoring the current time, whether the set is on or off and to which channel the set's tuner is tuned. The set meter then transmits the recorded data over a phone line to the Nielsen Media Research group. However, in most cases this recorded data doesn't directly inform a ratings server of the content that was viewed. The recorded data simply reports time and channel settings which must then be mapped to the particular programming being displayed within that broadcasting region. This mapping process requires that the content providers cooperate with the ratings agency to provide a channel map. The channel map provides a listing of the dates, times, and channels of the various programs available within the broadcasting region. Aggregate information from across the country is analyzed to estimate the number of viewers of a particular program, using the viewing habits of the monitored participants as a representative sample of the viewing public at large.

Networks then use the ratings information provided by Nielsen Media Research to help determine the cost of an advertising time slot based on the size of the audience that will likely see that advertising. For example, an advertiser will typically pay more to show advertisements during a program determined to have an audience of one million people than during a program determined to have only half a million viewers.

Despite its important role, the Nielsen rating system has been subject to much scrutiny and criticism over factors in the method that may contribute to inaccurate ratings reports. However, the Nielsen rating system is still the most commonly used method for determining the likely audience size of a particular television program in the traditional broadcast model and, consequently, the cost to advertise in association with that particular program.

While the Nielsen rating method, as described here, is readily used for stationary television sets, such as in a home, it is not suitable for use when a mobile device is used to receive a broadcast of television programming over a wireless network. Consequently, it may be more difficult to put an accurate value on advertising time in a broadcast of television programming to mobile devices over a wireless network. Nevertheless, as networks continue to improve their delivery of television programs and advertisements to the ever-growing population of mobile devices, valuing and pricing the advertising opportunity will become increasingly important to those networks.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram illustrating a system for collecting information regarding the viewing choices of mobile device users who can view television programming on a mobile device supported by a wireless network, according to one illustrative embodiment.

FIG. 2 is a block diagram illustrating the system of FIG. 1 being deployed through multiple service provider networks, according to one embodiment of principles described herein.

FIG. 3 is a block diagram illustrating another possible aspect of the system shown in FIG. 1, according to one embodiment of principles described herein.

FIG. 4 is a chart showing one illustrative packet format for transmitting streaming media, according to one embodiment of principles described herein.

FIG. 5 is a diagram showing an illustrative system utilizing real time transport protocol for communication of streaming media, according to one embodiment of principles described herein.

FIG. 6 is a diagram showing an illustrative method for collecting wireless usage data from mobile devices for ratings purposes, according to one embodiment of principles described herein.

Throughout the drawings, identical reference numbers designate similar, but not necessarily identical, elements.

### DETAILED DESCRIPTION

An illustrative system and method are described herein that enable the collection of information from mobile devices that are used to receive broadcasts of television or video programming over a wireless network. According to one illustrative embodiment, one or more ratings servers collect information associated with the use of one or more mobile devices to view broadcast video or programming. The collected information can then be used to calculate ratings.

As used herein and in the appended claims, the term “ratings” refers to the result of a numerical analysis estimating the total number of viewers watching a program, advertisement, or using another service or feature that is provided over the supporting wireless network. Similarly, the term “usage information” or “usage report” is used to refer to information that is used to generate ratings, including a record of decisions by individual users to watch particular broadcast programs. Additionally, as used herein “usage information” or “usage report” may include information on other content or services, aside from video or television programs, accessed with a mobile device. Thus, the usage information or report may be a complete picture of the use to which the user puts the mobile device and which can be used to not only rate the popularity of television or video programming, but also other content or services accessible with the mobile device. Such additional content or services may include, for example, games, web pages, audio files, pictures, promotional videos, advertisements, search results, or any other audiovisual content or service. Such content or services may be accessed by connecting to the Internet or worldwide web with the mobile device.

As described herein, a user may willingly agree to participate in the ratings program. Accordingly, a ratings server downloads a ratings application onto the participant's mobile device or activates a ratings application that was preloaded on the mobile device. When activated based on the user's election to participate in the ratings program, the ratings application then generates a record of the programming or video viewed or other services used with that mobile device.

The information recorded by the ratings application may include, but is in no way limited to, a listing of the programs or videos watched, a listing of advertisements watched, the time intervals during which the mobile devices was used to watch video or television programming, whether the device was stationary or moving within the service area during the time the video or television programming was viewed, the location of the mobile device at the start and/or end of a program and the like. The participant may also provide demographic information about himself or herself that is associated with the information collected by the ratings application. Any or all of this information may be included in the definition of “usage information” or “usage report.”

The recorded information collected by the ratings application can then be sent from the mobile device to a ratings server where the data collected from a plurality of participants can be aggregated and analyzed for ratings purposes. In some embodiments, the recorded usage information sent to the ratings server may be transmitted in such a way so as to accommodate anonymous participants, i.e., where the usage information is not associated with an individual user.

Multimedia Broadcast/Multicast Services (MBMS) is the organization that sets standards for video or television broadcasts by cellular and mobile telephone networks. Television broadcasting to mobile devices will include both an unregistered broadcast form and a registered multicast form of transmitting video. With a registered multicast, the broadcast server is aware of each user's identity for routing and charging purposes. In contrast, during an unregistered broadcast, the broadcast server may not be aware of the identity of individual recipients.

As used herein and in the appended claims, the term “content provider” will be used to refer to the entity that produces and markets video television programming. Thus, a content provider may be a television studio or similar company.

In contrast, the term “service provider” will be used herein and in the appended claims to refer to the owner or operator of a wireless network over which video or television programming from a content provider may be broadcast. Consequently, the service provider may or may not have any affiliation with the content provider or content providers whose work is broadcast over the service provider's network.

As used herein and in the appended claims, the term “wireless network” refers to any wireless network over which data, including video or television programming, can be transmitted to mobile devices, where each mobile device has an electronic identity, even if that identify is not used in receiving a broadcast of television programming as in an unregistered broadcast. Examples of wireless networks including mobile and cellular telephone networks, wireless fidelity (WIFI) hotspots and the like. The term “wireless network” does not include traditional over-the-air terrestrial television broadcasting in which a television may be portable but has no electronic identity and cannot communicate upstream back to the broadcaster. Television and video program and other content may be transmitted to a mobile device though currently used wireless protocols, as well as future planned wireless communication protocols and methods of transfer, such as 3G, 4G, LTE, WiMax, UMB, WiFi, 802.11, 802.16, GSM, GPRS, EVDO, HSPA, CDMA and other methods capable of distributing such data.

As noted above, with a registered multicast under the MBMS standards, the broadcast server of the service provider is aware of each user's identity for routing and charging purposes. Consequently, the service provider could use this information to produce usage information or a record of what television or video programming each viewer selected to watch. However, basing ratings on such information clearly requires the cooperation of the service provider who has exclusive access to that data from the broadcast server.

One significant advantage of the ratings application described herein is that it is a solution that does not require any cooperation or affiliation with the service provider other than, in some embodiments, use of the service provider's network to transmit data like any other network customer. Thus, the ratings server and the population of mobile devices may be configured to exchange information to support a ratings analysis without soliciting information from the service provider. For example, the desired information regarding what users are watching is collected by the ratings applications on the population of mobile devices and reported to a ratings server through routine transmissions of data over the service provider's network and without requiring any special intervention or assistance from the service provider.

Consequently, the present illustrative system allows for independent or collaborative ratings services to operate simultaneously on the same wireless network. According to one illustrative embodiment, the communication from the mobile devices to the ratings server is transmitted via standard data/IP access, and does not solicit any information from the service provider. Accordingly, the present illustrative system and method allows for both charging and incentive mechanisms separate from the service provider's involvement.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, a “mobile device” is defined as a device that is mobile within a wireless service area defined by a supporting wireless network and that can be used to view video or television programming received from the supporting wireless network. For example, mobile devices as defined herein may include, but are not limited to, mobile and cellular telephones, personal digital assistants (PDAs), laptops, tablet computers, handheld computers, MP3 players, palm-top computers, and/or other devices capable of receiving wireless signals and displaying video or television programming.

As used herein and in the appended claims, the term “video” will refer to motion picture video that is broadcast or streamed to a mobile device. The term “television programming” will be used to refer to video or television programming that is broadcast to mobile devices over a wireless network on a broadcast schedule. The term “mobile television” will specifically refer to television programming intended for, or broadcast to, a population of mobile devices.

An overview describing the interaction of a mobile device and a rating server will now be provided to demonstrate, according to one illustrative embodiment, how usage information for rating purposes may be obtained. Following the overview, specific details of the system and method will be provided in reference to the drawings.

The mobile device is operated by a user. A user choosing to participate in the ratings program is considered, and referred to herein, as a participant. When a user opts to become a participant in the ratings program and provide information about his or her viewing choices, an application, hereafter referred to as the ratings application, is activated on the user's mobile device. This may entail downloading the ratings application from the ratings server to the mobile device. As described herein, the ratings application tracks the video and television programming and/or other services accessed with the mobile device. Alternatively, the rating application can be preinstalled on the mobile device and simply activated by the user or by the ratings server when the user chooses to become a participant.

With the ratings application operational on a mobile device, usage information, including both selections of video and television programming as well as other content or services, may be recorded by the ratings application and subsequently reported to a ratings server. The usage information may include many different aspects of usage and may be adapted as best suits a particular application or desired purpose.

As a specific example, a participant using a wireless device such as a mobile phone may choose to watch television through a mobile television service provider such as V-Cast™. As the participant watches programs, the ratings program on the mobile phone collects and records the channels the participant is watching and during what time intervals the channels are viewed. The ratings application, without disrupting or requiring the interaction of the participant, transmits the collected usage information to the ratings server. In the same manner, the server may be receiving usage information from multiple participants using a variety of mobile devices.

According to one embodiment, the method used for communication between the mobile device and the ratings server involves any method for secure internet protocol (IP) data transfer over public networks. The data link through which data is sent from the mobile device to the ratings server need not be through the wireless network that delivers content, such as television or video programming, to the mobile device. If there is some other wireless network or other communications link available, a ratings application on a particular mobile device may send collected usage information to the rating server through an IP or other data transfer method rather than through the wireless network of the mobile service provider.

According to one illustrative embodiment, the ratings server, after acquiring usage information from a population of mobile devices, may be accessed by clients with an interest in this information. The ratings server may be configured to analyze the aggregate of information collected from a population of participants to develop a numerical analysis representing the number of viewers who watched a given television or video program, advertisement, or other content or service. Furthermore, the information compiled by the ratings server may be shared with a plurality of clients working separately or in collaboration, where each client may have limited or unrestricted access to the collected usage information.

Particularly where content, such as a television program, is available to both traditional television sets and to mobile devices through a wireless network, the ratings information provided to clients may include the usage information received from mobile devices in aggregation with usage information received from stationary television sets or other devices reporting usage information. According to this illustrative embodiment, at least one central server collects usage information from each ratings server that receives usage information from participating mobile devices and combines this information with ratings information originating from stationary devices to develop a comprehensive ratings report. This enables a central server to provide usage information from all participating mobile and stationary devices. The central ratings server may provide a client with all or a portion of the usage information, or alternatively, may provide the client with a customizable analysis of the usage information, such as a numerical rating.

According to one illustrative embodiment, the usage information transmitted from the mobile device to the ratings server includes information identifying the user. Alternatively, a user may elect to become an anonymous participant. If this is the case, the usage information may be transmitted from the mobile device to a ratings server in such a way so as to prevent the usage information from being associated with any given mobile device or participant.

The preceding overview of the present illustrative system and method for collecting usage information is described in further detail below with reference to the Figures.

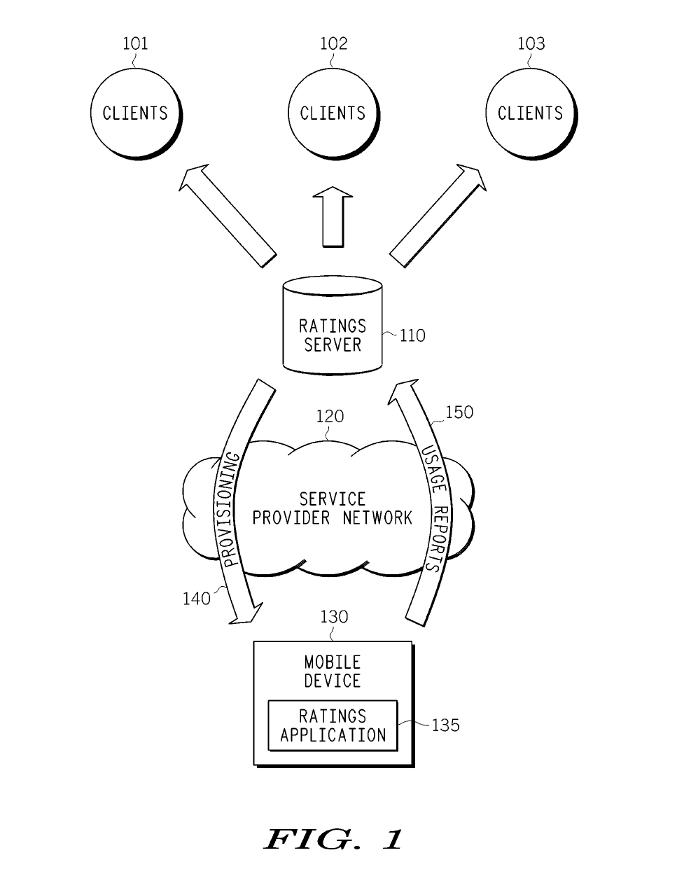

FIG. 1 is a block diagram illustrating a system for collecting information regarding the viewing and other content choices of mobile device users who can view television programming on a mobile device supported by a wireless network. As can be seen in FIG. 1, one or more clients (101, 102, 103) are able to access and communicate with a ratings server (110). These clients (101, 102, 103) may be, for example, entities selling advertising opportunities in connection with programming or other content to be delivered to mobile devices. The client's (101, 102, 103) may also be content providers who wish to ascertain the success of their various content offerings. Any party wishes access to usage information about the video or television programming or other content and services offered by a service provider may be a client.

As described above, the ratings server (110) contains information received from a population of mobile devices (e.g., 130) that are being used by participants in the ratings program. For ease of explanation only, a single mobile device (130) is illustrated in FIG. 1. However, it will be understood that this device (130) is representative of a population of mobile device, at least some of which are reporting usage information to the ratings server (110).

As described above, the ratings server (110) acquires usage information from a population of mobile devices (e.g., 130). The ratings server (110) analyzes the aggregate of information collected from the population of mobile devices (e.g., 130) to develop a numerical analysis representing the number of viewers who watched a given television or video program, advertisement, or other content or service. The ratings server (110) may include two or more servers or other devices configured to perform these functions. The ratings server (110) may also include any number of data storage devices or memory devices for storing usage information and derived ratings results.

A mobile device user desiring or persuaded to participate in the ratings program becomes a participant when that user's mobile device (e.g., 130) has a ratings application executing thereon. In the example of FIG. 1, the ratings application (135) is downloaded to the mobile device (130) and activated by the ratings server (110). This may be done through the “provisioning” communications link (140) shown in FIG. 1.

The illustrative mobile device (130) includes both a processor and at least one memory device. The ratings application (135) may be processor-readable instructions that are stored in the memory of the mobile device (130) and executed by the mobile device's processor. In general, a processor (e.g., a microprocessor) receives instructions from memory and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a hand held mobile device). Such a medium may take many forms, including, but not limited to, non-volatile media, volatile media, and transmission media. Non-volatile media may include, for example, optical, magnetic disks NOR and NAND-type flash memory, and other persistent memory, any of which may be used alone or in combination to form the main memory. Volatile media may include, for example, static random access memory (SRAM) and dynamic random access memory (“DRAM”), either of which may constitute main memory.

As shown in FIG. 1, the ratings server (110) is configured to communicate and selectively transmit a ratings application through the “provisioning” path shown by the arrow (140) extending from the ratings server (110) to the mobile device (130) through a service provider's network (120). The provisioning arrow (140) represents an illustrative data path the ratings application follows from the ratings server to be installed on the mobile device (130).

As indicated, the illustrative “provisioning” data path (140) passes through the service provider network (120). However, this data path (140) is treated like any other data transmission moving through the service provider network (120). As noted above, the method and system described herein make user of the service provider network (120) for data transmission, but require no further cooperation or assistance from the service provider to collect and analyze usage information. With this independence from the service provider, the ratings collection program is free to provide incentives and charge fees to participants and clients (101, 102, 103) independent of the service provider. By not soliciting usage information from the service provider, the ratings server (110) is not subject to stipulations created by service providers.

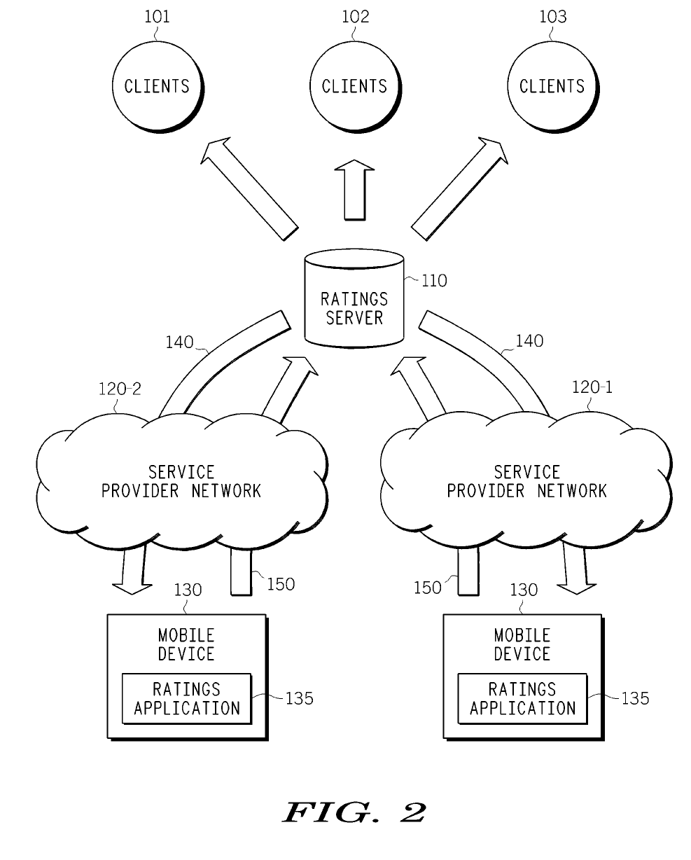

Additionally, because the collection of usage information is not dependent on cooperation from a service provider, participants may communicate with the ratings server (110) through different service provider networks (120-1, 120-2). This embodiment is illustrated in FIG. 2

In the present illustrative embodiments, where the interaction between the mobile device (130) and the ratings server (110) is not dependant on the service provider (120), the data path (150) represents any of the known methods of secure Internet protocol (IP) data transfer over public networks. Methods of IP data transfer include but are not limited to, Dynamic Host Configuration Protocol (DHCP), Transmission Control Protocol (TCP), User Datagram Protocol (UDP), File Transfer Protocol (FTP), Secure Shell (SSH), and any other compatible data transfer protocols or methods.

By way of example, the data paths (140, 150) providing communication between the ratings server (110) and the mobile devices (e.g., 130), and providing communication between the ratings server (110) and the clients (101, 102, 103) may utilize Third Generation Partnership Project (3GPP) standards and specifications. Specifically, according to one illustrative embodiment, the data paths may incorporate Long Term Evolution (LTE) utilizing Evolved Packet System (EPS) specifications that incorporate an Evolved Packet Core (EPC). Additionally, as the 3GPP continues to develop new standards and specifications, the presently disclosed system and method for collecting usage information and delivering corresponding ratings information can be adapted to any method of data transfer that suitably allows for data transmission between the illustrated devices.

According to one illustrative embodiment, the data transfer mechanism can be performed in any adequate way ensuring that the collected usage information is transmitted from the mobile device (130) to the ratings server (110). According to one illustrative embodiment, data transfer is typically modeled as a seven layer open systems interconnection (OSI) model. According to the OSI model, the seven layers are: application, presentation, session, transport, network, data link, and the physical layer. According to the model as described above, any number of combinations are possible (e.g. choose a method from the session method and it may be implemented using many methods from the other six layers). According to one illustrative embodiment, the ratings program is configured to provide a mechanism to record and collect usage information of a mobile device and transmit the same information to a ratings server. According to this illustrative embodiment, at least one portion of the data transfer may include protocols incorporating connections through wireless fidelity (WiFi), 802.11, 802.16, 802.22, 802.20 (Mobile-Fi), WiMax, General Packet Radio Service (GPRS), Evolution Data Optimized (EVDO), High Speed Packet Access (HSPA), Global System For Mobile Communications (GSM), Long Term Evolution (LTE), Code Division Multiple Access (CDMA), methods utilizing Time Division Multiplexing Access (TDMA) or Frequency Division Multiplexing Access (FDMA), Space Division Multiple Access (SDMA), Carrier Sense Multiple Access (CSMA), Multiple Frequency Time Division Multiple Access (MF-TDMA), Synchronous Code Division Multiple Access (S-CDMA), Orthogonal Frequency Division Multiplexing (OFDM), and many other methods utilizing frequency, time, spatial, and code multiplexing, combinations thereof, or any other data link layer method capable of wireless data transfer.

In some embodiments, the data paths (140, 150) shown in FIGS. 1 and 2 each represent a number of different data paths between intermediate devices. For example, the mobile device (130) may utilize a wireless protocol to send usage information to an intermediate device that is part of, in communication with, or substitutes for, a service provider network (120). According to this illustrative embodiment, the intermediate device then transfers the data to any number of other intermediate devices until the information finally arrives at the ratings server (110). Data transfer from one intermediate device to another, or from an intermediate device to the ratings server (110), may be performed utilizing any method of secure data transfer, including those mentioned above, but not necessarily through a wireless data link.

Additionally, while the present illustrative system and method are described herein as incorporating a wireless transfer of data between the mobile device (130) and the ratings server (110), the data such as the “usage reports” (on path (150)) or “provisioning” (on path (140)) may also be transmitted via a wired connection over the internet using a home computing device and the like. Alternatively, it may be desirable that the service provider network (120) be included in the data path rather than utilizing data transfer over public networks.

Once the user has requested to participate and the ratings application is downloaded to or otherwise activated on the mobile device (130), the mobile device becomes an active participant in the ratings program. The ratings application may also be, at any later date, upgraded or modified to perform different tasks. According to the present illustrative embodiment, the present ratings application is configured to collect and record usage information. As indicated above, usage information may include any variety of statistics and details. The usage information may be as detailed as to illustrate exactly what was watched during each interval, thereby allowing the clients (101, 102, 103) to extrapolate from the data not only which programs were watched, but also what advertisements were viewed by the user. According to one illustrative embodiment, the usage information may be associated with a demographic client profile that may include things such as age, location, annual income, travel time to work, education, and any number of identifying attributes.

According to one illustrative embodiment, the demographic information related to the client profile may be collected from the user when the ratings application is activated and registered. By including demographic information along with the usage information, clients (101, 102, 103) can tailor the advertising sold in connection with a particular video or television program or other content to the likely interests or needs of the demographic group or groups that are the primary audience for that content. However, according other embodiments, a user may elect to participate anonymously, with no user profile information being associated with the usage information transmitted from the mobile device (130) to the ratings server (110).

As indicated above, in some embodiments, the usage information recorded by the ratings application (135) on a mobile device (130) may also include information regarding other content or services used by the participant. For example, the ratings application may record information demonstrating how often the participant utilizes other services provided by a mobile device (130) or by the service provider (120) including, but in no way limited to, how often a participant uses the calculator, map and direction programs, chat programs, text messaging, voice mail, camera, calendar, email applications, internet access features, multimedia function, or any other conceivable service that may be provided. By configuring the ratings application to record the use of such services, a client (101, 102, 103) may be able to determine the use of those services, as well as the value of advertisements associated with those services.

There are a wide variety of possibilities for attaching or combining additional data with the usage reports (150). For example, it may be desirable in some circumstances to include the type of mobile device that displayed the media content. Knowing the device type and device capability could answer questions such as how many people are watching High Definition Television (HDTV) programming on non-HDTV devices. Similarly, the applications installed and/or used within the device could be reported together with the usage data.

Another type of data which could be included in the usage data is geospatial location and/or velocity information. Many mobile devices now contain Global Positioning System (GPS) receivers which allow the mobile device user to ascertain their present position, velocity, and the history of their past motion. Additionally, location information can be ascertained by determining which transponder the mobile device is communicating with. By including this information in the usage report, the services and programming consumed by the user could be put into a fuller context. The location of the user while consuming content could be pinpointed to a particular cell phone tower, an office building, or other location. Additionally, velocity could give added context by allowing the level or type of activity being performed by the user to be deduced. For example, if no velocity is reported, it could be assumed that the user was stationary while viewing the content. The stationary user may be sitting at a desk, waiting for transportation, or eating at a restaurant. If a moderate velocity is reported, it may be predicted that the user is walking or jogging. Higher velocities may indicate that the user is traveling in a car, train, or airplane.

Other examples of types of data that could be included within the usage report include the network used for the data download and the method of reception. The network used to download the media data can be valuable in determining which of the types of wireless networks the mobile device utilized to access the data. Mobile devices have multiple wireless interfaces and can access networks through a variety of communication protocols including network protocols (CDMA/GSM/LTE/UMTS), WiFi, WiMax, BlueTooth, and others. In some circumstances, advertising broadcast over different networks may have different advertising content. For example, a broadcast of “Everybody Loves Raymond” on CBS eye on America could be accessed by a user flying on Lufthansa airlines through local-cast by Lufthansa WiFi or the same show could be accessed on the ground over a standard network connection. While the primary media content could be the same, the advertising content could be significantly different. Thus, knowing the network used for the data download would help a ratings service accurately determine the audience that a particular advertiser was accessing.

Additionally, the method of reception could be reported within the usage report. For example, content could be broadcast (such as on CNN), multicast (such as a sports game pay-per-view), or unicast (such as a movie pay-per-view). For example, a user may watch “The Tudors” when it was broadcast Sunday night on Showtime or the user can watch the same show using a video-on-demand method at a later time. The advertising content may vary significantly depending on the method of reception.

As discussed above, the privacy of the user could be protected by allowing the contributing user to opt into various levels of usage reporting and filtering the collected data to remove personally identifying information.

Returning to FIG. 1, once the ratings application is active on the mobile device (130) the ratings application collects and records usage information. According to one illustrative embodiment, the usage information may be recorded on a memory device associated with the mobile device (130) until the information is ready to be transferred. The usage information is then transmitted on the reverse data path (150) to the ratings server (110). According to one illustrative embodiment, the reverse data path (150) may be any transmission, whether over a wireless network or a wired connection that transmits usage reports from the mobile device (130) to the ratings server (110). As illustrated in FIG. 1, the reverse data path (150) may, according to one illustrative embodiment, pass through the service provider network (120) without requesting usage information from the service provider network, thereby leaving the ratings server (110) free to provide incentives and charge fees to participants and clients (101, 102, 103) independent from the service provider (120).

In one embodiment, the contributing user of the mobile device may become a consumer of the aggregated usage data. The ratings server could be configured to provide near real time ratings data that shows the most popular programming at a given time. This real time ratings data could be distributed as a programming guide listing the most popular programs among current users.

Additionally, in some illustrative embodiments, the ratings application may be configured to allow a contributing user to send the usage data to another individual or a social network. The message from the contributing user may be very simple, such as “I am currently watching this content.” In other circumstances, the message may include a more comprehensive history of the user's viewing habits. For example, a viewing history may be posted within a social networking site as a statement of identity or personal preference.

Additionally, the example of FIG. 1 shows only a single rating server (110) for ease of explanation. It will be understood, however, that systems and method described herein may be extended to having any number of ratings servers. In some embodiments, each server may be communicating with a different segment of the population of participant mobile devices. In such embodiments, the usage information received by each ratings server can be combined to form a complete conglomerate of usage information representing every participating mobile device.

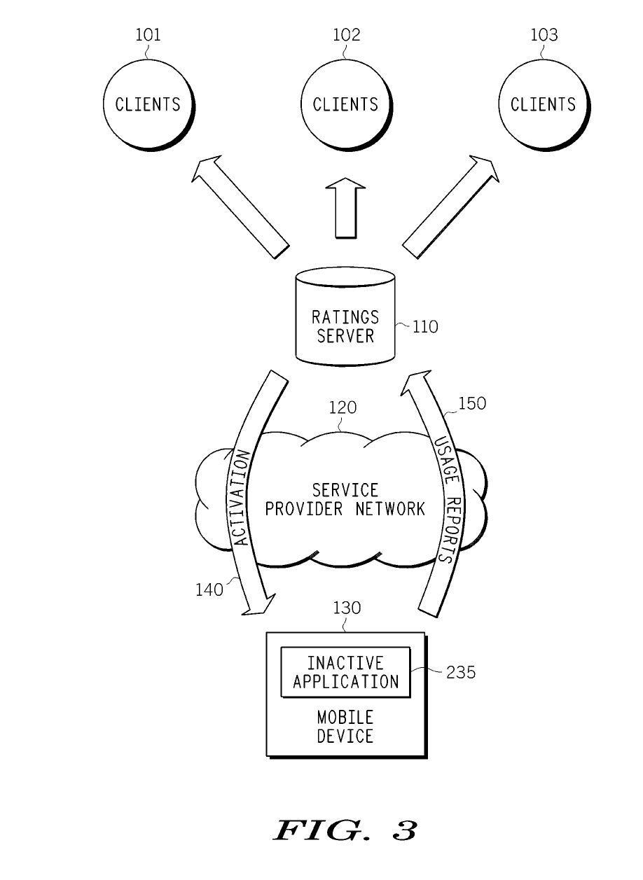

FIG. 3 is a block diagram illustrating another possible aspect of the system shown in FIG. 1. As described above in connection with FIG. 1, a “provisioning” data path provided a download of the ratings application to a new participant mobile device. In contrast, in the embodiment of FIG. 3, the ratings application (235) is already loaded on the mobile device (130), but is inactive. The ratings application (235) may be loaded on the mobile device (130) by a manufacturer or by a service provider when the mobile device is deployed for use with a particular network (120). Alternatively, the application (235) may be downloaded in an inactive state by the user of the mobile device (130) and remain inactive until activation as described here.

When the user elects to participate in the ratings program, the ratings server (110) activates the ratings application (235) that is preinstalled on the mobile device (130). Consequently, an “activation” data path (140) is shown extending from the ratings server (110) through the network (120) to the mobile device (130). Thus, the manner in which a user elects to participate in the ratings program is by activating a previously installed ratings application (235) Once the mobile device (130) initializes the inactive application (235), usage information is collected, recorded and subsequently sent through the reverse data path (150) to the ratings server (110).

In this illustrated embodiment, the ratings application (235) is not limited to being a software application. Rather, according to various illustrative embodiments, the ratings application (235) may be implemented through hardware or firmware. For example, according to one illustrative embodiment, a user may elect to participate in the ratings system and authorize the ratings server (110) to update the firmware of the mobile device (130) with firmware containing the ratings application. Alternatively, the user electing to become a participant may manually activate previously inactive hardware innate to the mobile device (130), or authorize the ratings server (110) to do so, thereby activating the usage information reporting function of the application (235).

As used in the preceding description and in the subsequent description and claims, the term “ratings application” shall include any of the above described forms of ratings applications, implemented through software, firmware or hardware, or combinations thereon, and shall not be interpreted narrowly to only include software as the term application commonly indicates.

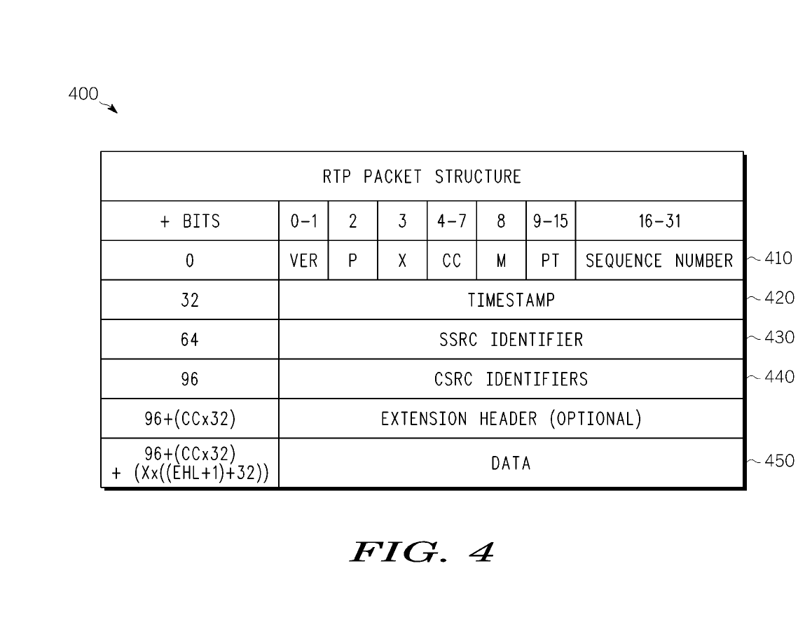

As previously discussed, a number of communication protocols could be used to communicate media content to a mobile device. According to one embodiment, real-time transport protocol (RTP) could be used to define standardized packet formats for delivering audio and video over a wireless connection. FIG. 4 is a chart showing one illustrative RTP packet structure (400) for transmitting streaming media. A first line (410) is a fixed header containing bits 0-31 which define the following RTP packet structure (400). For example, the first line (410) contains variables relating to the version of the protocol (Ver.), padding at the end of the packet (P), extensions to the protocol (X), the number of contributing sources (CC), the format of the data payload (PT) and the sequence number. The sequence number is a packet identifier that assists the receiving device in reassembling the data in the correct order after receiving the various packets that make up the message. The time stamp (420) allows for synchronization and jitter calculations.

The synchronization source (430) is a 32-bit numeric SSRC identifier carried in the RTP header so as not to be dependent upon the network address. All packets from a synchronization source (430) form part of the same timing and sequence number space, so a receiver groups packets by synchronization source for playback. Examples of synchronization sources (430) include the sender of a stream of packets derived from a signal source such as a microphone or a camera, or an RTP mixer (see below). The SSRC identifier is a randomly chosen value meant to be globally unique within a particular RTP session. If a participant generates multiple streams in one RTP session, for example, from separate video cameras, each must be identified as a different SSRC. The contributing source identifiers (440) identify the original source of content that has been subsequently modified or combined with other sources. The media data (450) then follows the header and other structured identifiers.

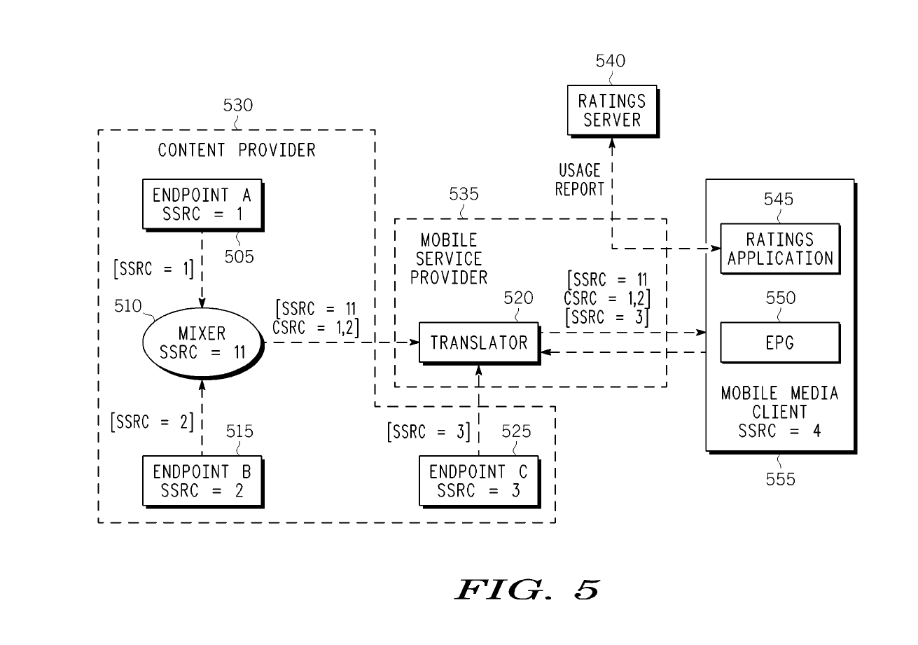

FIG. 5 is a diagram showing an illustrative method for collecting wireless usage data from mobile devices for ratings purposes. In particular, FIG. 5 illustrates the role of the synchronization source identifiers (430) and contributing source identifiers (440) in tracking the original source of media content communicated through a network. By tracking the source identifiers (430, 440; FIG. 4) in each data packet (400; FIG. 4), the original source of the media content contained within the packet can be determined. A receiving element may group packets by synchronization source for play back and order the packets within a group using the sequence number or timestamp (420).

The system (500) may comprise a number of endpoints (505, 515, 525, 530) which each have a unique synchronization identifier. An endpoint (505, 515, 525, 530) is an element that generates content to be sent by RTP packets and/or consumes the content in received RTP packets. An endpoint (505, 515, 525, 530) can act as one or more synchronization sources in a particular RTP session, but typically only one.

A mixer (510) is an intermediate system that receives RTP packets from one or more sources, possibly changes the data format, combines the packets in some manner and then forwards the new stream of RTP packets. All data packets originating from a mixer will be identified as having the mixer as their synchronization source. The synchronization identifiers from the original sources are collected by the mixer (510) and inserted as contributing source identifiers. For purposes of illustration the 32-bit synchronization source values are represented as small integers.

For example, endpoint A (505), with a synchronization source number of 1, generates content and sends it to a mixer (510). Similarly, endpoint B (515), with a synchronization source number of 2, generates content and sends it to the mixer (510). The mixer (510) combines the content and sends out the packet stream with a synchronization source number of 11. Each packet in the stream has a synchronization number of 11 and contributing source numbers of 1 and 2. Consequently, any elements that receive that packet stream can identify both the original sources of the content and the intermediate mixer. Endpoint C (525) also generates a stream of data that is identified by the synchronization source number 3. The packet streams generated by Endpoint C (525) do not pass through a mixer and thus retain their original synchronization source number.

According to one exemplary embodiment, the endpoint A (505), the endpoint B (515), endpoint C (525) and the mixer (510) may be controlled by a content provider (530). In this simplified example, endpoint A (505) and endpoint B (515) may provide the primary video and audio content while endpoint C (515) may provide an advertisement content.

A mobile service provider (535) may utilize a translator (520) to receive RTP packets from one or more sources and forwards the packets with their synchronization source and contributing source identifiers intact. Consequently, packets passing through the mobile service provider (535) network remain traceable to their original sources by any receiving devices. Examples of translators include devices that convert encodings without mixing, replicators from multicast to unicast and others.

A mobile media client (555) also acts as an endpoint and has its own synchronization source identifier. According to one illustrative embodiment, the mobile media client (555) comprises an electronic program guide (550) and a ratings application (545). The user of the mobile media client (555) uses the electronic program guide (550) to select programming the user desires to view. The electronic program guide (550) then translates this selection into a request for content that is conveyed to the mobile service provider (535). This request may be transferred in a variety of ways, which may vary among service providers and among different mobile devices. In one embodiment, the electronic program guide (550) may map the user's selection to a synchronization source identifier and pass that synchronization source identifier to the mobile service provider (535). The translator (520) then begins streaming the content to the mobile device through a packet stream. As previously discussed, each packet may have a synchronization source identifier and a number of contributing source identifiers that identify the original and intermediate sources of the content. In the example shown in FIG. 5, the translator (520) may first pass a portion of the primary video and audio content to the mobile media client (555). As previously discussed, this primary media stream would have a synchronization source identifier of 11 and contributing source identifiers of 1 and 2. The translator (520) may then send an advertisement originating from endpoint C (525) with a synchronization source identifier of 3.

According to one illustrative embodiment, the ratings application (545) then samples the header of one or more packets within the packet stream and records the synchronization source and contributing source identifiers, time stamps, and any other relevant data. The ratings application may then use the mapping contained within the electronic program guide to translate the identifiers into textual descriptions of the content, human-readable identifiers, or other classifying information. This information is passed as a usage report to the ratings server (540). As discussed previously, this usage report may be transmitted through the service provider's network just as any other message would.

Because each of the various media streams received by the mobile media client (555) is uniquely identified, it is possible for the ratings application to distinguish between advertising and primary content. Consequently, the information passed to the ratings server (540) can be very precise in identifying content.

FIG. 5 illustrates only one of many possible methods for obtaining ratings information from data streamed to a mobile media client. By way of example and not limitation, the mobile media device may communicate through a separate network to connect to the ratings server, or, the ratings application may pass raw synchronization and contributing source identifiers to the ratings server rather than access the electronic program guide. In addition, the ratings application may not be required to intercept packets sent to the mobile media client (555), but may simply record the requests for content made through the electronic program guide (550). In an alternative embodiment, the content could be multicast to both the ratings server (acting as a client) and the mobile media client. The ratings server could then directly sample the content being streamed to the mobile device. Additionally, a variety of protocols in addition to RTP could be leveraged to produce content identifying information.

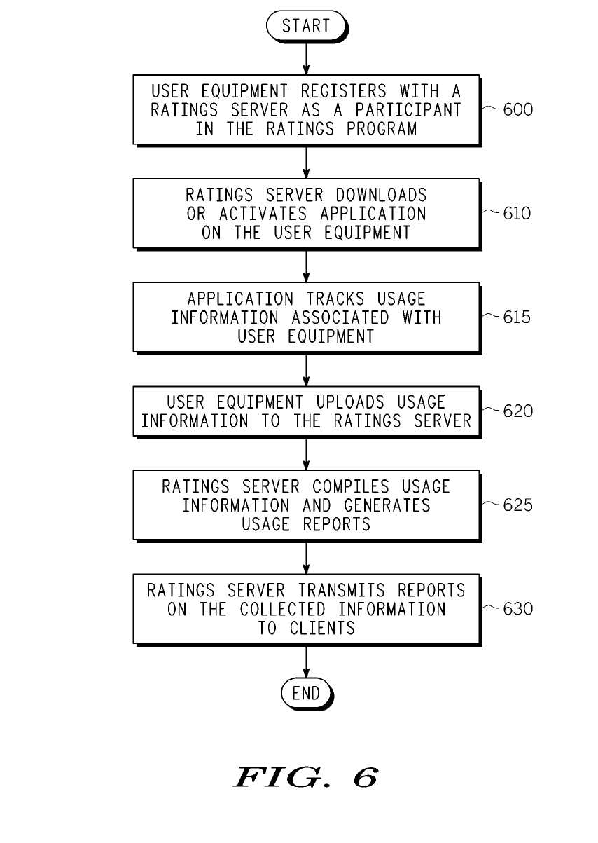

FIG. 6 is a flow chart illustrating a method for collecting information regarding the viewing choices of mobile device users who can view television programming on a mobile device supported by a wireless network, according to one illustrative embodiment. As illustrated in FIG. 6, the user of the mobile device (130; FIG. 1) elects to become a participant in the ratings collection program and registers with a ratings server as a participant in the ratings program (step 600).

According to one illustrative embodiment, election by mobile device user to be a participant in the ratings program may be accomplished by registering with a ratings server via a wireless connection, over the internet, or via any other communication. This registration may include uniquely identifying the mobile device to the ratings server, providing demographic information regarding the user of the mobile device and verifying the user or mobile device as a source of usage information. In some examples, the user activates a preinstalled ratings application, which transmits a signal to the ratings server that the device has elected to become a participant. Registration may then occur as indicated.

When the mobile device is identified as a participant, the ratings server is configured to receive and recognize communications transmitted by the mobile device. Absent registration with the ratings server, data received from the mobile device may be ignored as a security feature of the rating server and to maintain the integrity of the data collected.

Once the mobile device registers with the ratings server as a participant, the ratings server may download a ratings application to the mobile device (step 610). However, in other examples, the mobile device may have an inactive ratings application already installed that is then activated by the user or the rating server. Whether through one of the above mentioned methods or through a different method, once a ratings application is operational on a mobile device, the mobile device becomes a participant and is configured to actively communicate with the ratings server.

Once the ratings application is operational on a mobile device, the ratings application begins collecting usage information associated with the registered mobile device (step 615). As indicated above, the term “usage information” shall be interpreted broadly as including any number of statistics pertaining to the use of the mobile device. According to one illustrative embodiment, usage information is understood to include time intervals the user watched mobile television. Additionally, the usage information collected may include, but is in no way limited to, the exact time that the mobile device displayed mobile television, what channels the mobile device displayed, the advertisements displayed by the mobile device, when the channel was changed, volume settings during each time interval, buttons pushed during a time interval, the location of the device at the start and/or end of a viewed program, or any other information that may assist in determining ratings statistics.

According to some embodiments, the usage information may be tagged with demographic information as described above in connection with usage information. It may also be tagged with who the user's service provider is.

As the ratings application records and collects usage information, the information may be transmitted to the ratings server (Step 620). According to one illustrative embodiment, the usage information is transmitted to the rating server from the mobile device in real-time. Alternatively, the information may be stored on the mobile device for later transmission. Whether transmitted to the ratings server as the ratings application collects the usage information, or recorded for a time and then transmitted as a larger quantity of information, the collected and recorded usage information is eventually transmitted to the ratings server.

As described above, the ratings server may physically be several servers or a single server, but is herein referred to as the ratings server. Furthermore, as mentioned previously, the ratings server is in communication with any number of mobile devices or equipment, all of which transmit usage information to the ratings server.

According various illustrative embodiments, once the ratings server has received a predetermined amount of usage information from the various mobile devices or equipment, the ratings server compiles the usage information and generates any number of usage reports for the ratings clients (step 625). Any number of specialized reports may be compiled by the ratings server as desired by the ratings clients including, but in no way limited to, reports dealing specifically with the viewing statistics of the mobile device, reports correlating the viewing statistics of the mobile device with the effectiveness of advertising, reports correlating the viewing statistics of the mobile device with the use of other functions on the mobile device, reports correlating the viewing statistics with other known demographics of the user associated with the mobile device, and any combinations of the like.

Once the ratings server has compiled the usage information and generated the desired usage reports, the information is made available to ratings clients (step 630). According to various embodiments, the clients may have access to only a select portion of the collected usage information. Alternatively, the clients may have access to all of the collected usage information. When the clients have access to all of the collected usage information, the client may process the information to extrapolate the desired ratings statistics, such as how many people watched a particular program, or the number of people belonging to a specific demographic group who watched a particular advertisement. Alternatively, statistical ratings information may be extracted from the collected usage information by the ratings server and then provided to various clients.

In conjunction with any variation of the above described method, clients may be charged for the information received from the ratings server. Additionally, participating users may be provided with incentives to become participants. According to one illustrative embodiment, providing for the collection of usage information without soliciting information from service providers allows for the implementation of charging and incentive mechanisms without consideration of the service provider. Independence from the service provider also permits the ratings program to be implemented with any willing user, rather than exclusively those users who belong to a selectively participating service provider.

Furthermore, the present illustrative ratings program may be integrated into standard core services provided to mobile users operating mobile devices. For example, the illustrative rating program in any of its embodiments described above may be incorporated fully or in part into the Motorola IMS (IP multimedia subsystem) core service; resulting in the interaction between the mobile device and the ratings server to be implemented through methods currently used in IMS frameworks.

According to another illustrative embodiment, a user can be both a participant and a client. Such a participant not only actively supplies the ratings server with usage information but also has access to at least a portion of the aggregate usage information received by the ratings server. Accordingly, a user may have access to a list of the most viewed video or television programs or other content extrapolated from the aggregate of information provided to the ratings server. This may help the user find and access new programs or content of interest to that user. For example, in some embodiments, a mobile device has access to a channel guide in which the channels available through a mobile television service for the mobile device are sorted by those most viewed.

The preceding description has been presented only to illustrate and describe possible embodiments of the present illustrative system and method. It is not intended to be exhaustive or to limit the present system and method to any precise form disclosed. Many modifications and variations are possible in light of the above teaching. Modification of the above disclosure may include only pieces of the process as exclusive entities or combinations of pieces to form a useful application in which various described elements of the disclosure are not incorporated. It is intended that the scope of the present illustrative system and method be defined by the following claims.

What is claimed is:

1. A system for collecting usage information from a mobile device, comprising:
at least one ratings server configured to communicate with a population of mobile devices over a network;
said at least one ratings server being further configured to receive and collect usage information from said population of mobile devices over said network;
said at least one ratings server being further configured to produce ratings of content available to said mobile devices based on said usage information.

2. The system of claim 1, wherein said at least one ratings server is further configured to selectively report at least a portion of said ratings to one or more clients.

3. The system of claim 1, wherein said at least one ratings server is further configured to communicate with a ratings application resident on said mobile device, said ratings application being configured to report said usage information about usage of said mobile device to said ratings server.

4. The system of claim 3, wherein said ratings server registers said mobile device before accepting said usage information from said mobile device.

5. The system of claim 1, wherein said ratings server is further configured to activate a ratings application that is loaded, but inactive, on said mobile device, said ratings application being configured to report said usage information about usage of said mobile device to said ratings server.

6. The system of claim 3, wherein said mobile device is configured to receive digital media data in a packet, said packet comprising content identifying information and media data.

7. The system of claim 6, wherein said ratings application is configured to extract said content identifying information from said packet and report said content identifying information to said ratings server.

8. The system of claim 7, wherein said content identifying information is mapped into a human-readable content identifier using an electronic program guide.

9. The system of claim 7, wherein said packet is in a real time transport protocol format, said content identifying information being one or more of: a synchronization source and a contributing source.

10. The system of claim 1, wherein said usage information comprises a listing of video and television programs accessed with said mobile device as well as other content accessed with said mobile device.

11. The system of claim 10, wherein said usage information further comprises at least one of: geospatial location, geospatial velocity, mobile device type, applications being used on said mobile device, network used for data download, method of reception, and use of mobile device functions.

12. A method for collecting usage information from a population of mobile devices, comprising:
reporting usage information for each mobile device of said population with a ratings application installed on each said mobile device; and
receiving and analyzing said usage information with a ratings server to produce ratings of content available to said mobile devices based on said usage information.

13. The method of claim 12, further comprising extracting source identifying information from a media data stream received by said mobile device and saving said source identifying information on said mobile device.

14. The method of claim 13, wherein said extracting source identifying information comprises extracting at least one of: a synchronization source identifier and a contributing source identifier.

15. The method of claim 13, wherein said ratings application maps said content identifying information to a human readable content identifier using an electronic program guide resident on said mobile device.

16. The method of claim 12, wherein said ratings server is configured to provide near real time ratings data to clients.

17. The method of claim 16, wherein a contributing user is a client.

18. The method of claim 12, wherein said ratings application is configured such that a contributing user can independently use and communicate said usage information.

19. The method of claim 12, wherein said ratings server is configured to communicate with said population of mobile devices over at least two different networks.

20. The method of claim 12, wherein said usage information comprises a listing of video and television programs accessed with said mobile device as well as other content access with said mobile device.
